(19) United States
(12) Patent Application Publication
(10) Pub. No.: US 2011/0017077 A1
(43) Pub. Date: Jan. 27, 2011

(54) Food Preparation and Display System

(76) Inventor: David L. Magiera, Arlington, TX (US)

Correspondence Address: Klemchuk Kubasta LLP, 8150 N Central Expressway, SUITE 1150, DALLAS, TX, 75206, US

(21) Appl. No.: 12/831,867

(22) Filed: Jul. 7, 2010

Related U.S. Application Data
(60) Provisional application No. 61/227,741, filed on Jul. 22, 2009.

(51) Int. Cl. A47J 37/04; A47J 36/00

(52) U.S. Cl. 99/419; 99/446

(57) ABSTRACT

The present disclosure could generally provide systems and methods of food preparation and display and, in particular, flambé displays in a safe and cost effective manner and include an apparatus to aid in flambéing and displaying flambéed food items such as skewered meats, vegetables, fruits, or other food item. The alcohol or flambé liquid could be poured on the skewered items and set on fire in a relatively contained system having a tray, a cradle, skewers with removable handles, and various accessories. Excess liquid is retained in fluid cups on the ends of each skewer and in tray thus keeping the handle of each skewer clean and free from excessive heat.

### CROSS REFERENCE TO RELATED APPLICATION

This application claims benefit under 35 U.S.C.§119(e) of U.S. Provisional Patent Application Ser. No. 61/227,741 filed on Jul. 22, 2009 in the United States Patent and Trademark Office entitled “Food Preparation and Display System.” The entire disclosure of U.S. Provisional Patent Application Ser. No. 61/227,741 is incorporated by reference as if fully disclosed herein.

### TECHNICAL FIELD

The present disclosure relates generally to food preparation systems and methods, and in particular to food preparation and display systems for, for example, flambéing foods.

### BACKGROUND

Flambé is a French term meaning “flamed” that refers to a cooking procedure in which alcohol and, in particular, ethanol is added during the cooking process to a hot pan to create a burst of flames within the pan. The flames are a result of the combustion of alcohol. Not all alcohols appear to flambé well. For example, wines and beers have too little alcohol to flambé, while rum, cognac, and other liqueurs typically are around 80 proof or 40% alcohol work well for flambé. In addition, the open flames and general nature of flambé presentations make it very dangerous and most prudent restaurants, cruise ships, and other venues bar the use of flambé at table-side presentations and displays.

What is needed is a safe and cost-effective system and method of making and using flambé presentations and displays and food displays.

### SUMMARY

Embodiments of the present disclosure could generally provide systems and methods of food preparation and display and, in particular, flambé displays in a safe and cost effective manner.

In one embodiment, the present disclosure could generally provide a system of displaying food. The system could include a cradle having a retaining structure. The system could also include a skewer having a first end with a removable handle and an open end. The retaining structure could be configured to receive a portion of the handle.

In one embodiment, the present disclosure could generally provide a system of displaying food. The system could include a cradle having a plurality of retaining structures. The system could also include a skewer having a first end with a handle and an open end to thread food items on to the skewer. The system could further include a retaining structure configured to receive a portion of the handle. The system could still further include a concaved cylindrical structure disposed on one end of the handle to capture liquids running from the skewer.

In one embodiment, the present disclosure could generally provide a system of displaying food. The system could include a cradle having a retaining structure. The system could also include a plurality of skewers each having a handle threadably connected to an elongated portion of the skewer. The retaining structure could be configured to retain the plurality of skewers and comprises a concaved cylindrical structure disposed on one end of each of the handles to capture liquids running from the skewer.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1A is a perspective view of a food preparation and display system according to one embodiment of the present disclosure;

FIGS. 1B-E are perspective views of a other food preparation and display systems according to one embodiment of the present disclosure;

FIG. 2 is a top view of a cradle for the food preparation and display system shown in FIG. 1A according to one embodiment of the present disclosure;

FIG. 3 is a top view of the cradle shown in FIG. 2 where the cradle is resting on a tray according to one embodiment of the present disclosure;

FIG. 4 is a perspective view of the food preparation and display system shown in FIG. 1A having a food container mounted on the cradle according to one embodiment of the present disclosure;

FIG. 5 is a perspective view of the food preparation and display system shown in FIG. 4 having a set of skewers mounted on the cradle according to one embodiment of the present disclosure;

FIG. 6 is a perspective front view of the food preparation and display system shown in FIG. 1A fitted with a dome according to one embodiment of the present disclosure;

FIG. 7 is illustrates the food preparation and display system shown in FIG. 6 and illustrating the dome in phantom according to one embodiment of the present disclosure;

FIG. 8 is an exemplary illustration of one method of providing a flambé presentation using the food preparation and display system shown FIG. 1A according to one embodiment of the present disclosure;

FIG. 9 is a top view of an another food preparation and display system and cradle according to one embodiment of the present disclosure;

FIG. 10 is a partial side view of the cradle shown in FIG. 9 according to one embodiment of the present disclosure;

FIG. 11 is perspective view of a dome used in conjunction with the food preparation and display system shown in FIG. 9 according to one embodiment of the present disclosure;

FIG. 12 is a front view of a pair of skewer tongs for use with the food preparation and display system according to one embodiment of the present disclosure;

FIG. 13 is an illustration of the skewer tongs shown in FIG. 12 in a disassembled state according to one embodiment of the present disclosure;

FIG. 14 is an illustration of one application for the skewer tongs shown in FIG. 12 according to one embodiment of the present disclosure;

FIG. 15 is a perspective view of the food preparation and display system having a drip screen according to one embodiment of the present disclosure; and

FIG. 16 is top view of the food preparation and display system and drip screen shown in FIG. 15 according to one embodiment of the present disclosure.

### DETAILED DESCRIPTION

The present disclosure could generally provide systems and methods of food preparation and display and, in particular, flambé displays in a safe and cost effective manner and include an apparatus to aid in flambéing and displaying flambéed food items such as skewered meats, vegetables, fruits, or other food item. The alcohol or flambé liquid could be poured on the skewered items and set on fire in a relatively contained system having a tray, a cradle, skewers with removable handles, and various accessories. In one embodiment, any excess liquid is retained in fluid cups on the ends of each skewer and in the tray thus keeping the handle of each skewer clean and free from excessive heat. The system is easy to maintain/clean and is relatively lightweight, thus safe, easy, and convenient to use at, for example, tableside at restaurants, cafes, cruise ships, banquet halls, and residential homes.

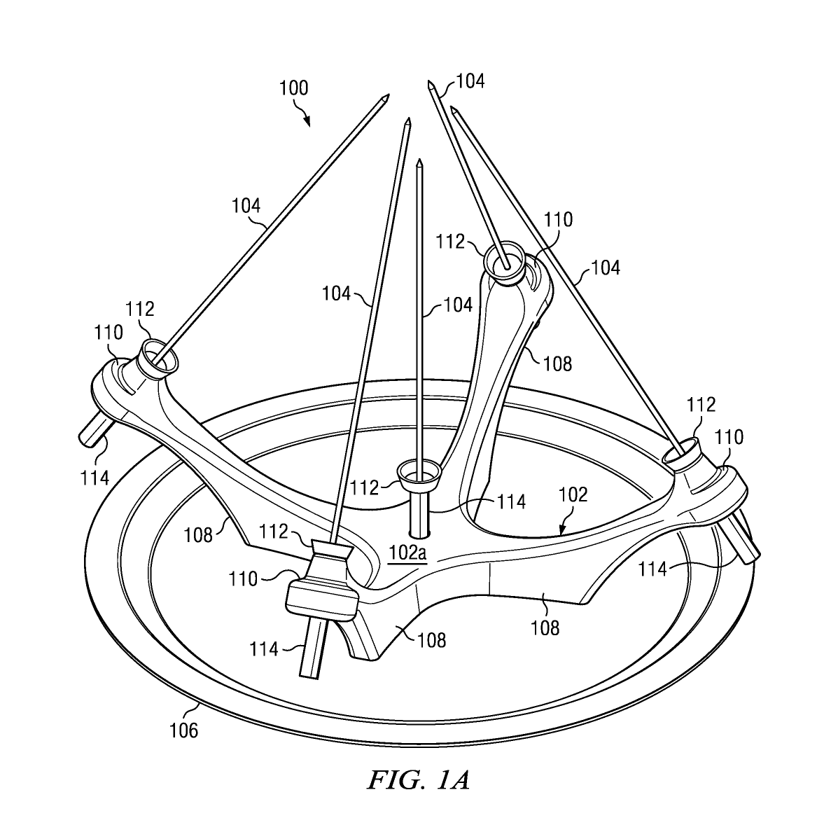

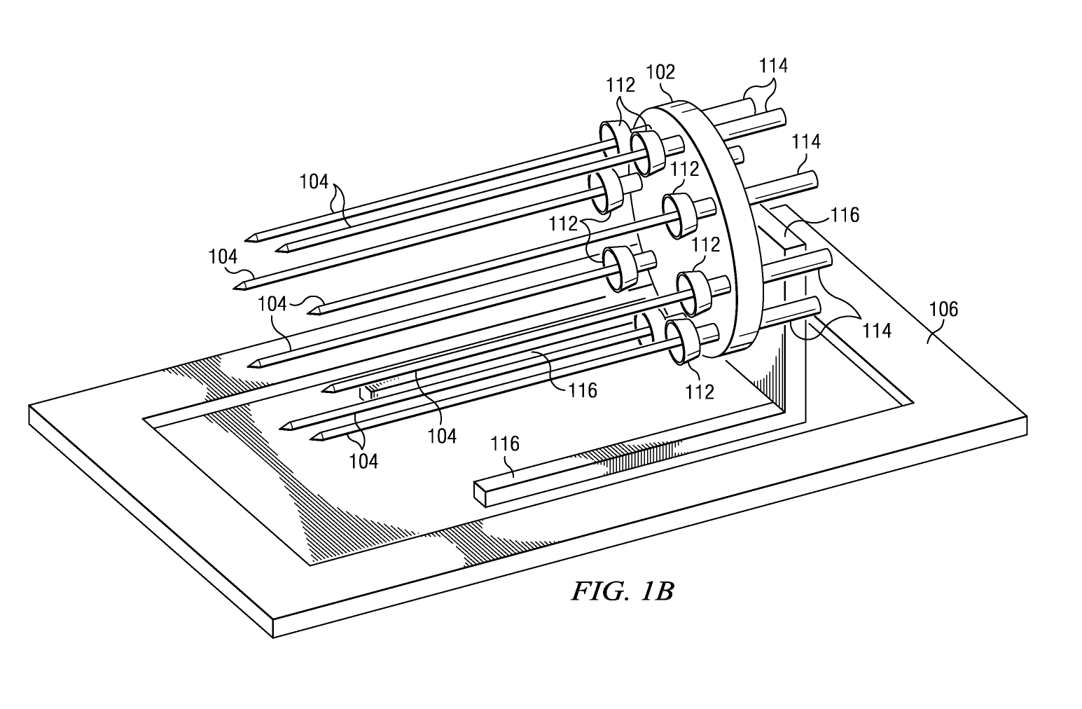

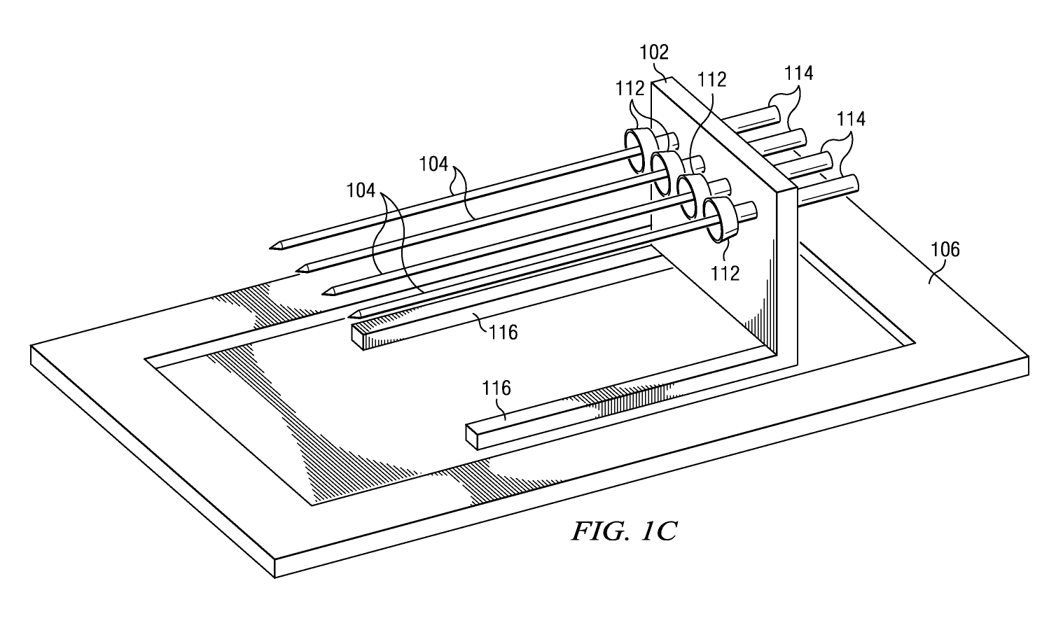

FIG. 1A is a perspective view of food preparation and display system 100a according to one embodiment of the present disclosure. In addition, FIG. 2 is a top view of cradle 102 for system 100a shown in FIG. 1A, while FIG. 3 is a top view of cradle 102 shown in FIG. 2 according to one embodiment of the present disclosure. It should be understood that system 100a and cradle 102 shown in FIGS. 1A, 2, and 3 are for illustrative purposes only and that any other suitable system, apparatus, or device could be used in conjunction with or in lieu of system 100a or cradle 102 according to one embodiment of the present disclosure. Although cradle 102 is generally shown as a somewhat circular cradle system, it should be understood that cradle 102 and system 100a could include any suitable structure, design, size, shape, or configuration.

System 100a could generally include a cradle 102, skewers 104, tray 106, elongated arms 108, retaining structures 110, receiving cup 112, and handle 114 as shown in FIG. 1A according to one embodiment of the present disclosure. In one embodiment, system 100a and parts of system 100a could be made of stainless steel to generally comply with safe handling and clean kitchen rules and regulations. It should be understood that, however, that system 100a and parts of system 100a could be made of any suitable material including, for example, steel, food-grade steel, chrome, aluminum, nickel-plated aluminum, mirror-polished cast aluminum, sterling silver, silver plated metal, platinum, copper, cast iron, other metals, plastics, thermoplastics, stone, granite, non-stick materials, wood, other suitable man-made or natural materials, or any combination thereof. In one embodiment, system 100a could include a weight of about 11.4 pounds (including 2 pounds of meat) and could be part of an ensemble having, for example, a sterling silver serving tray, a mirror polished cradle, multiple stainless steel skewers, a nickel plated cloche, a stainless steel drip screen, and stainless steel tongs.

Cradle 102 could generally include any suitable structure to secure or otherwise retain skewers 104 in a position relative to the other skewers 104 and tray 106 according to one embodiment of the present disclosure. In one embodiment, cradle 102 could include any suitable size, shape, or configuration to retain skewers 104 according to one embodiment of the present disclosure.

Skewers 104 could include an elongated body having a somewhat stick-like structure with a removable handle end having fluid receiving cup 112 and handle 114 to allow for ease of handling of skewers 104, and a skewering or threading end to skewer or otherwise thread food items such as, for example, meats, fish, kebabs, vegetables, fruits, marshmallows, candies, cheeses, breads, other food or novelty items, or any combination thereof on to skewers 104 according to one embodiment of the present disclosure. In one embodiment, skewers 104 could extend upwardly and angularly from cradle 102 to a center point of system 100a (i.e., at an acute or oblique angle relative to the horizontal plane) as generally shown in FIG. 1A.

Although skewers 104 shown in FIG. 1A with one generally solid cylindrical and elongated stick-like structure, it should be understood that skewers 104 could include any suitable structure including, for example, a pronged skewering end, a double pronged body, an apertured body, a grooved body, a ridged body, or any combination thereof. Although skewers 104 is generally shown as a somewhat stick-like structure, it should be understood that skewers 104 could include any suitable structure, design, size, shape, or configuration.

Tray 106 could be any suitable structure for supporting cradle 102 according to one embodiment of the present disclosure. Tray 106 may prevent cradle 102 from becoming dislodged and falling onto an underlying surface. Although a particular structure of tray 106 is generally illustrated in FIG. 1A, it should be understood that tray 106 could include any suitable structure, design, size, shape, or configuration.

Elongated arms 108 and retaining structures 110 could project from the center or base 102a of cradle 102 and be configured to accommodate one or more of skewers 104 as generally shown in FIG. 1A according to one embodiment of the present disclosure. In one embodiment, retaining structures 110 could include retainer 110a, aperture, or other suitable structure sized and shaped to retain or otherwise secure skewers 104 and/or handle 114 to cradle 102. Although particular structures of elongated arms 108 and retaining structures 110 are generally illustrated in FIG. 1A, it should be understood that elongated arms 108 and retaining structures 110 could include any suitable structure, design, size, shape, or configuration.

Receiving cup 112 could be used to capture and retain liquid flowing from skewers 104 and any food items on skewers 104 according to one embodiment of the present disclosure. By retaining the liquid, receiving cup 112 prevent flow of liquids including, for example, flambé liquids and/or meat juices to handle 114 and thus handle 114 remains relatively cool to the touch. Although a particular structure of receiving cup 112 is generally illustrated in FIG. 1A, it should be understood that receiving cup 112 could include any suitable structure, design, size, shape, or configuration.

Handle 114 could include a removable handle for skewers 104 according to one embodiment of the present disclosure. In one embodiment, handle 114 could include a threaded assembly configured to couple with one or more skewers 104. By having a removable configuration, handle 114 could be removed and separated from skewers 104 to clean, sanitize, or store away as desired according to one embodiment of the present disclosure.

In one embodiment, handle 114 could include a decorative or functional handle covering or accessory as desired. Although a particular structure of handle 114 is generally illustrated in FIG. 1A, it should be understood that handle 114 could include any suitable structure, design, size, shape, or configuration.

FIGS. 1B-E are perspective views of other food preparation and display systems 100b, 100c, 100d, and 100e according to one embodiment of the present disclosure. It should be understood that systems 100b, 100c, 100d, and 100e shown in FIGS. 1B-E are for illustrative purposes only and that any other suitable system, apparatus, or device could be used in conjunction with or in lieu of systems 100b, 100c, 100d, and 100e according to one embodiment of the present disclosure. Although systems 100b, 100c, 100d, and 100e generally include the similar components to system 100a shown in FIG. 1A and described above, systems 100b, 100c, 100d, and 100e could include any suitably sized, shaped, or configured components or subcomponents.

System 100b, 100c, 100d, and 100e could include cradle 102, skewers 104, tray 106, elongated arms 108, retaining structures 110, receiving cup 112, handle 114, and platform 116 as shown in FIG. 1B, 1C, 1D, and 1E, respectively, according to one embodiment of the present disclosure.

In one embodiment, cradle 102 shown in FIG. 1B could include a generally circular shaped, rotatable, reconfigurable, or stationary cradle-like structure to hold or otherwise retain skewers 104 in place relative to each other, while cradle 102 shown in FIG. 1C is a generally rectangular shaped cradle 102. Similarly, cradle 102 shown in FIG. 1D could include a generally triangular-shaped cradle 102, while FIG. 1E could include a generally semi-circular shaped cradle 102. Cradles 102 and platform 116 shown in FIGS. 1B-1E could include any suitable structure and could be customized, rotated, reconfigured, or left stationary, as desired.

In one embodiment, platform 116 could include an elongated supporting structure for system 100b that abuts against a surface of tray 106. Platform 116 could include a weighted structure sufficient to balance any load bearing on skewers 104 and cradle 102 in general according to one embodiment of the present disclosure. Although a particular structure of platform 116 is generally illustrated in FIGS. 1B-1E, it should be understood that platform 116 could include any suitable structure, design, size, shape, or configuration.

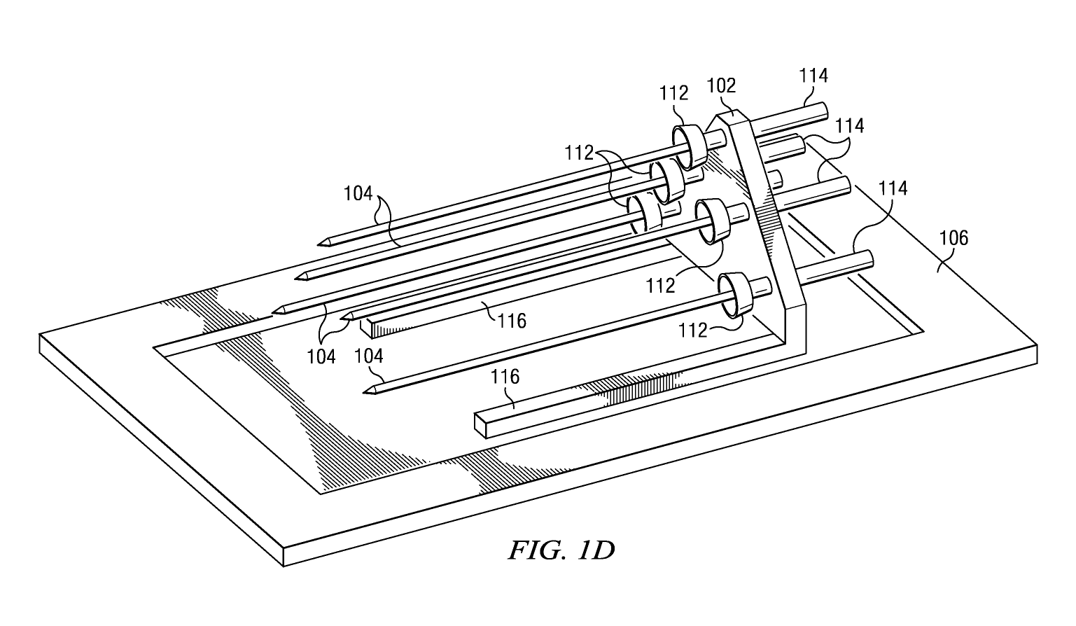

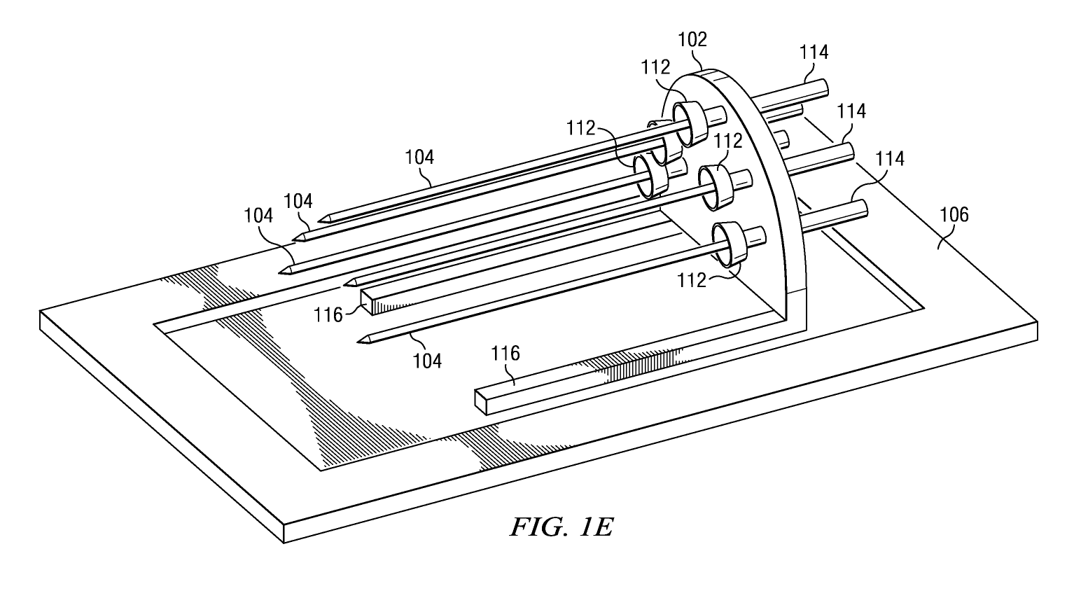

FIGS. 4 and 5 are perspective views of system 100a shown in FIG. 1A having bowl 402 mounted on cradle 102 according to one embodiment of the present disclosure. It should be understood that system 100a in FIGS. 4 and 5 is for illustrative purposes only and that any other suitable system, apparatus, or device could be used in conjunction with or in lieu of system 100a or bowl 402 according to one embodiment of the present disclosure.

Bowl 402 shown in FIGS. 4 and 5 could be used to retain or otherwise capture any liquid from the flambé or food items 502 either prepared or displayed using system 100a according to one embodiment of the present disclosure. In one embodiment, bowl 402 could include any container, receptacle, dish, plate, bowl-like structure, other suitable structure, or any combination thereof. Bowl 402 could include any suitable structure, design, size, shape, or configuration according to one embodiment of the present disclosure.

Food items 502 shown in FIG. 5 could include any suitable item for preparation or display using system 100a or any other similar system according to one embodiment of the present disclosure. In one embodiment, food items 502 could include any suitably sized, shaped, flavored, or number of meats, fish, vegetables, fruits, marshmallows, candies, cheeses, breads, other food items, or any combination thereof.

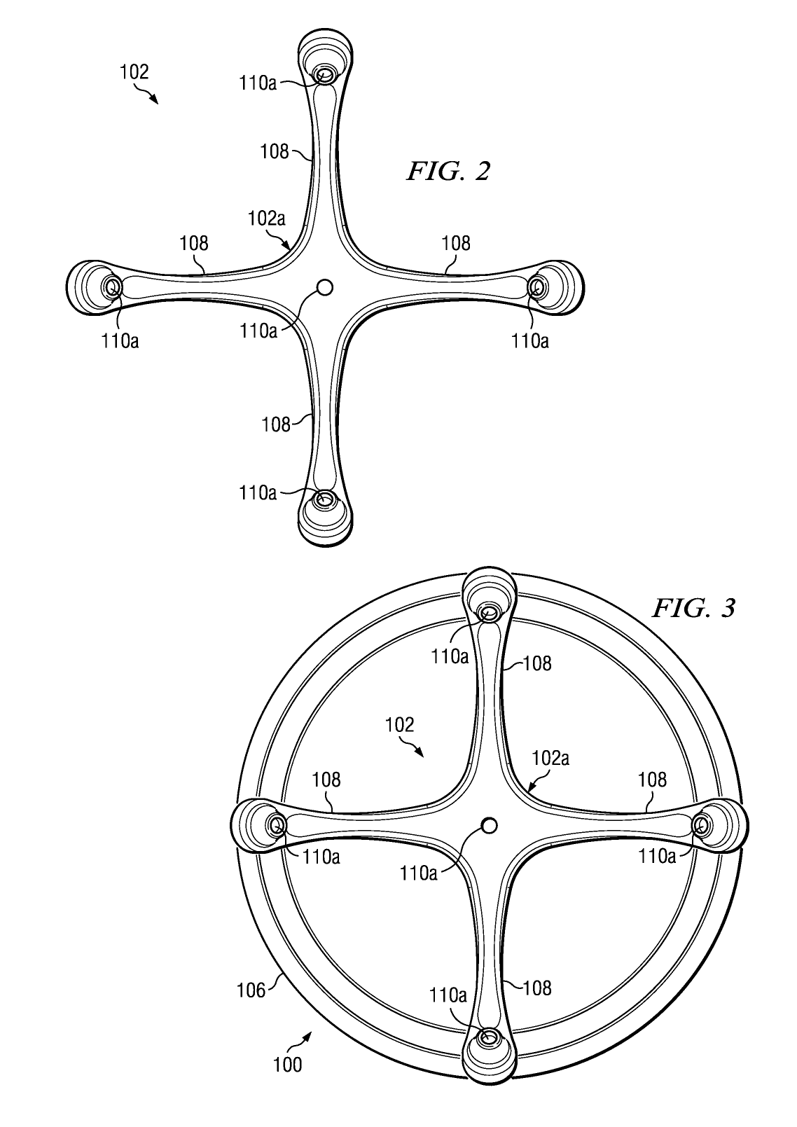

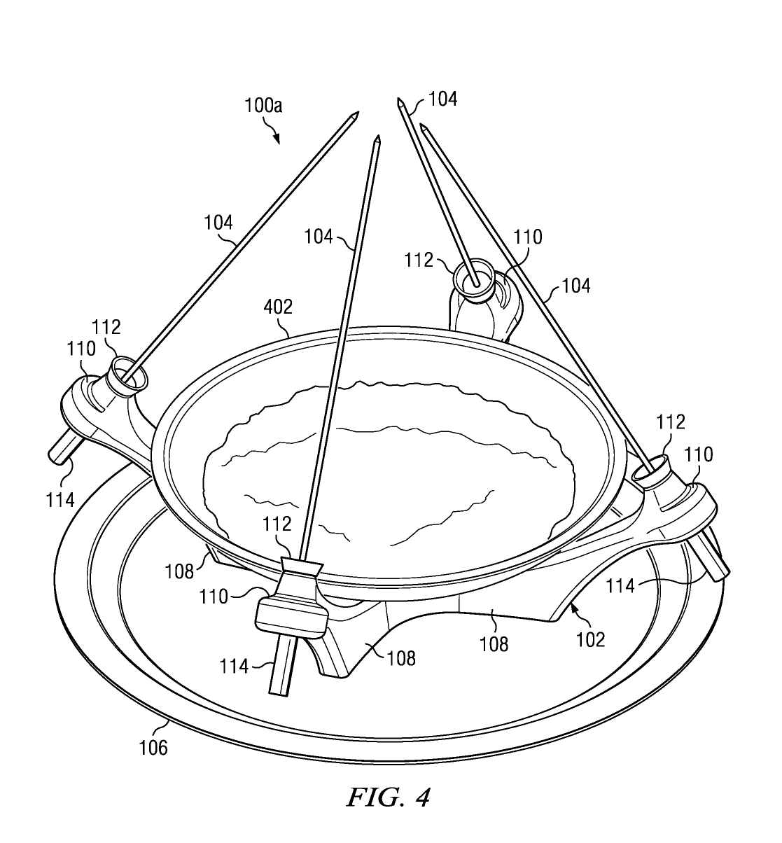

FIG. 6 is perspective front views of system 100a shown in FIG. 1A fitted with cloche or dome 602, while FIG. 7 illustrates system 100a with dome 602 shown in phantom lines according to one embodiment of the present disclosure. It should be understood that system 100a and dome 602 in FIGS. 6 and 7 are for illustrative purposes only and that any other suitable system, apparatus, or device could be used in conjunction with or in lieu of system 100a or dome 602 according to one embodiment of the present disclosure.

Dome 602 could be used to cover or otherwise enclose system 100a or parts of system 100a according to one embodiment of the present disclosure. In addition, dome 602 could be used to keep food items 502 warm or free from contamination and could prevent diners from knowing exactly what is supported on skewers 104 until dome 602 is physically removed. Dome 602 could also be used to extinguish any flames left from the flambé process. In one embodiment, dome 602 could include a generally concaved interior portion and handle 604. In one embodiment, dome 602 and handle 604 could include any suitable structure, design, size, shape, or configuration according to one embodiment of the present disclosure.

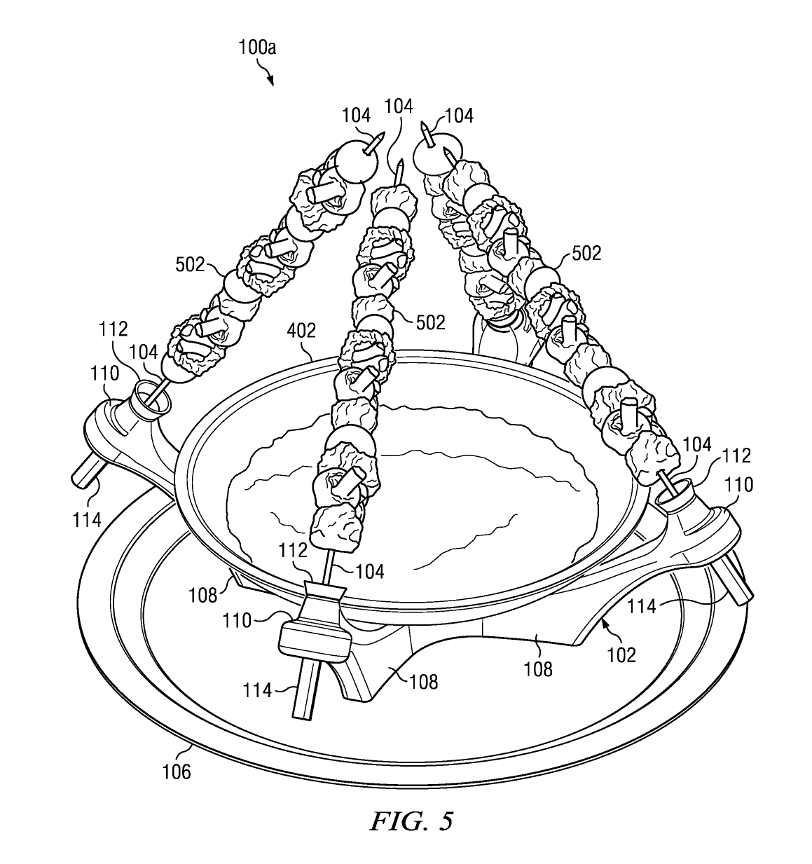

FIG. 8 is an exemplary illustration of method 800 of providing a flambé presentation using system 100a shown FIG. 1A according to one embodiment of the present disclosure. It should be understood that method 800 shown in FIG. 8 is for illustrative purposes only and that any other suitable method or sub-method could be used in conjunction with or in lieu of method 800 according to one embodiment of the present disclosure.

Method 800 could include lighting alcohol 802 in vessel 804 to produce a flame and pouring alcohol 802 generally over food items 502. It should be understood that alcohol 802 could be poured over food items before lighting alcohol 802. In any case, the flambé presentation and flames are a result of the combustion of alcohol 802. Alcohol 802 could include, for example, rum, cognac, liqueurs typically around 80 proof or 40% alcohol, other suitable alcohols, or any combination thereof. Additives, such as, for example, cinnamon, could be used to change, alter, or enhance the color of the flames.

Vessel 804 shown in FIG. 8 could be used to retain a desired quantity of alcohol 802 according to one embodiment of the present disclosure. In one embodiment, vessel 804 could include any container, pot, pan, receptacle, glass, cup, bowl, dish, plate, bowl-like structure, other suitable structure, or any combination thereof. Vessel 804 could include any suitable structure, design, size, shape, or configuration according to one embodiment of the present disclosure.

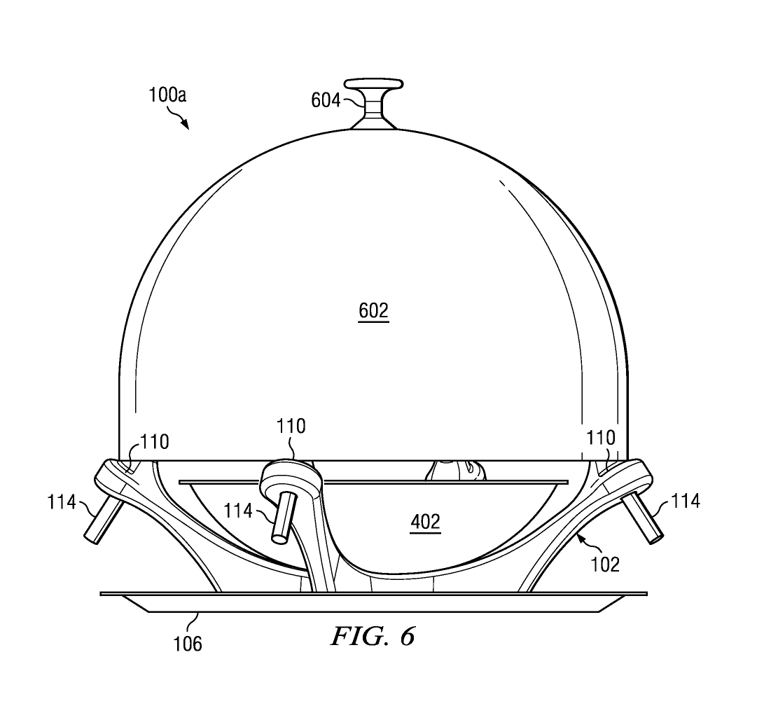

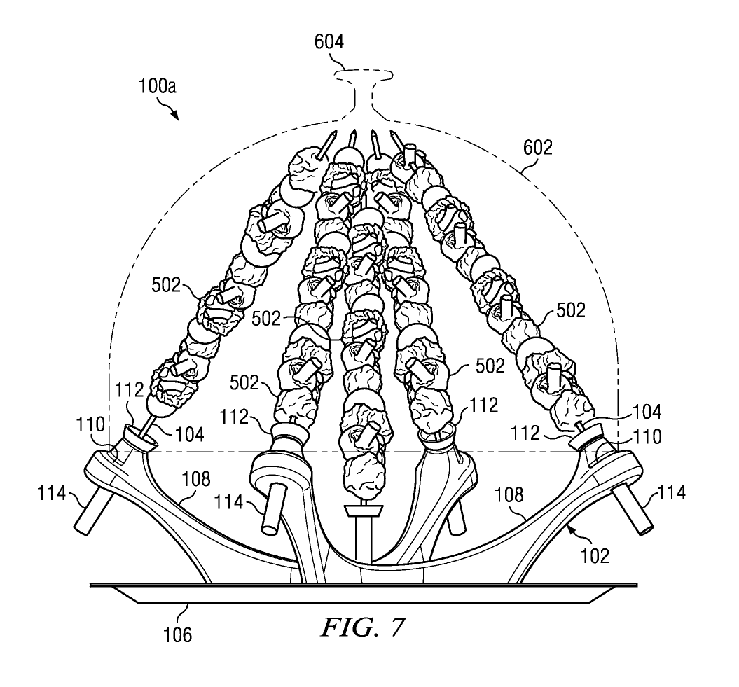

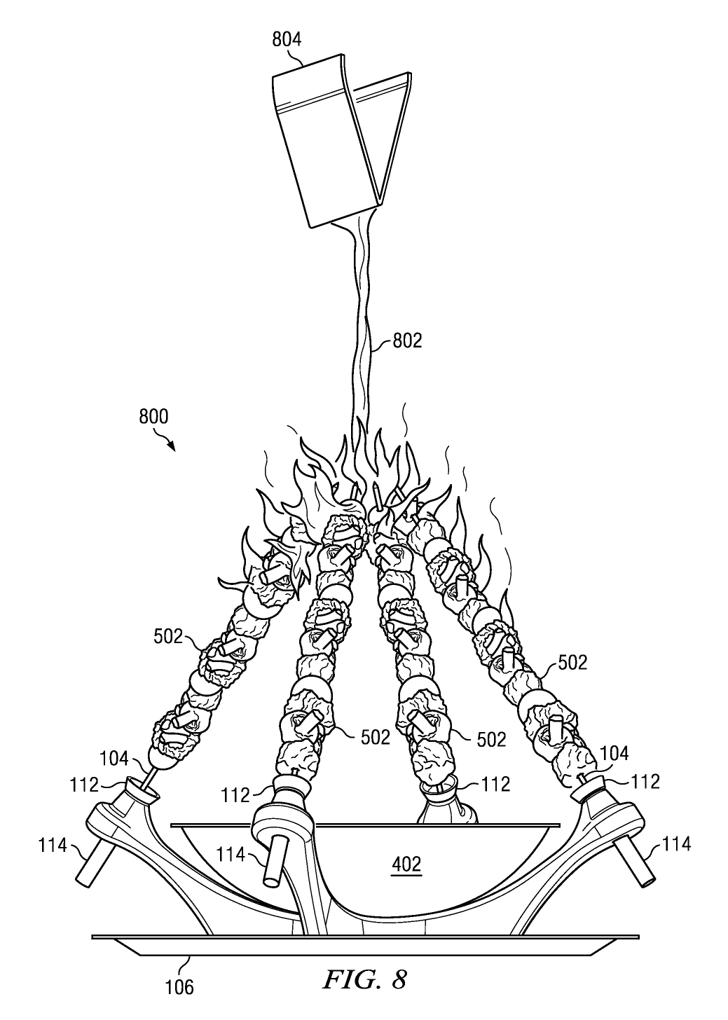

FIGS. 9, 10, and 11 illustrate food preparation and display system 1100 and cradle 900 according to one embodiment of the present disclosure. FIG. 9 is a top view of cradle 900, FIG. 10 is a partial side view of cradle 900, and FIG. 11 is perspective view of system 1100 according to one embodiment of the present disclosure. It should be understood that display system 1100 and cradle 900 in FIGS. 9, 10, and 11 are for illustrative purposes only and that any other suitable system, apparatus, or device could be used in conjunction with or in lieu of display system 1100 and cradle 900 according to one embodiment of the present disclosure.

System 1100 shown in FIG. 11 is similar to system 100a shown in FIG. 7 and includes cradle 900 shown in FIG. 9 according to one embodiment of the present disclosure. In one embodiment, system 110 could include an elongated cloche or dome 1102 and handle 1104. Dome 1102 could be similar to dome 602 shown in and described in conjunction with the description accompanying FIG. 6, while handle 1104 could be similar to handle 604 shown in and described in conjunction with the description accompanying FIG. 6 according to one embodiment of the present disclosure.

Cradle 102 shown in FIGS. 9, 10, and 11 could be similar to cradles 102 shown and described in conjunction with the description accompanying FIGS. 1A and 2-8 above according to one embodiment of the present disclosure. In one embodiment, retaining structures 110 could include retainer 110a, aperture, or other suitable structure sized and shaped to retain or otherwise secure a portion of one end of handle 114 to cradle 102 as shown in FIGS. 10, 11, and 15.

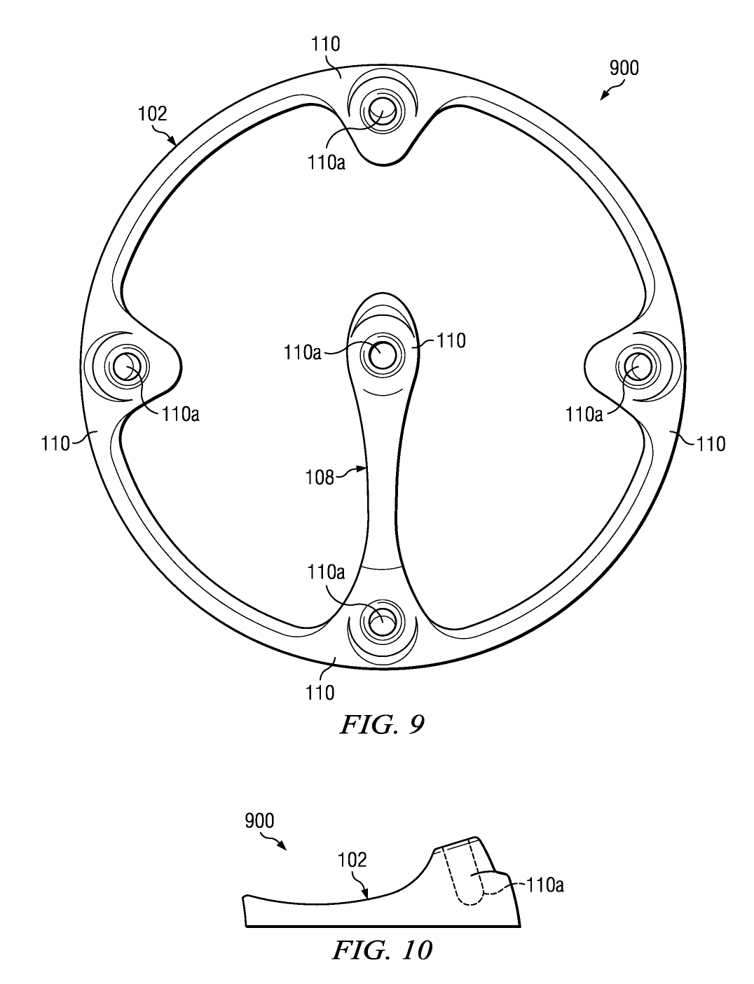

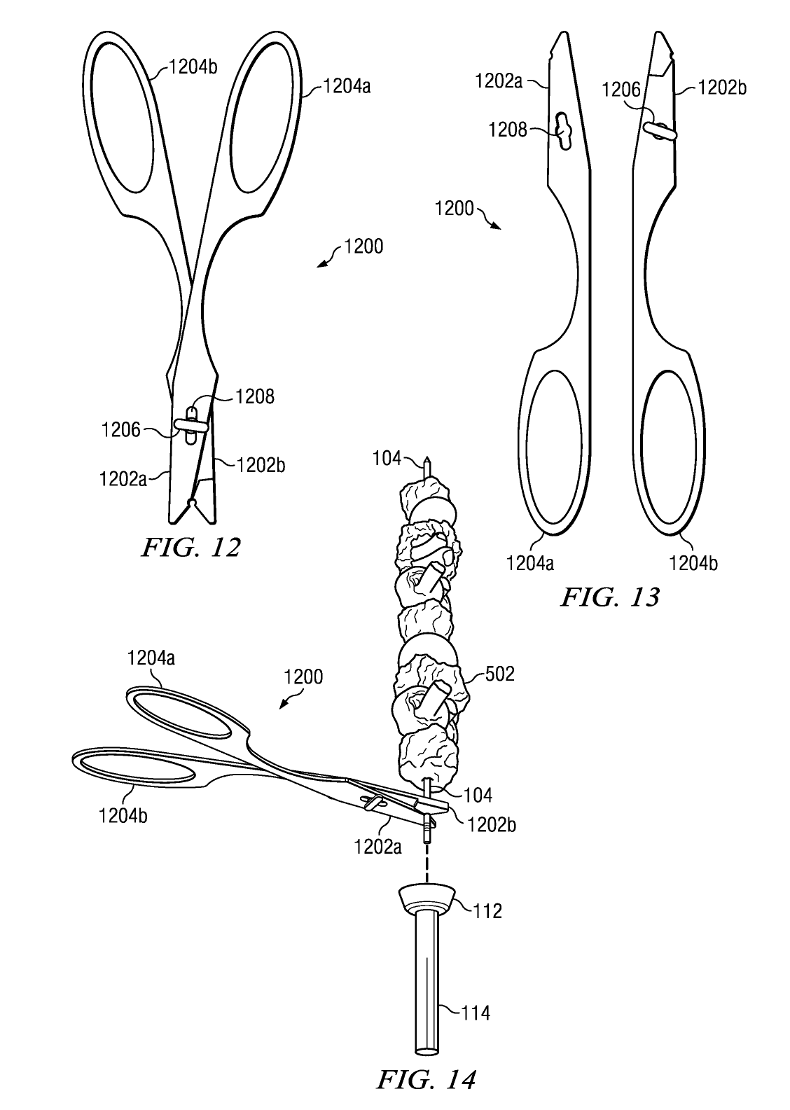

FIGS. 12, 13, and 14 illustrate tongs 1200 for use with system 100a according to one embodiment of the present disclosure. It should be understood that tongs 1200 shown in FIGS. 12, 13, and 14 is for illustrative purposes only and that any other suitable system, apparatus, or device could be used in conjunction with or in lieu of tongs 1200 according to one embodiment of the present disclosure. It should be understood that tongs 1200 could be used with any system similar to system 100 including, for example, systems 100b, 100c, 100d, 100e, 800, and 1100.

Tongs 1200 could be used to hold skewers 106 (especially when skewers 106 are hot) and/or to selectively disengage food item 502 from skewer 104 according to one embodiment of the present disclosure. In one embodiment, tongs 1200 could include two commonly hinged and opposing shearing edges or blades 1202a and 1202b configured in a scissor-like manner. Although a particular structure for tongs 1200 is shown in FIGS. 12, 13, and 14, it should be understood that tongs 1200 could include any suitable structure, design, size, shape, or configuration according to one embodiment of the present disclosure.

Blades 1202a and 1202b could include handle areas 1204a and 1204b, respectively, according to one embodiment of the present disclosure. In one embodiment, blades 1202a and 1202b could include any suitable number of grooves, slots, indents, or other structures to aid in disengaging one or more food items 502 from skewer 104. Although a particular structure for blades 1202a and 1202b are shown in FIGS. 12, 13, and 14, it should be understood that blades 1202a and 1202b could include any suitable structure, design, size, shape, or configuration according to one embodiment of the present disclosure.

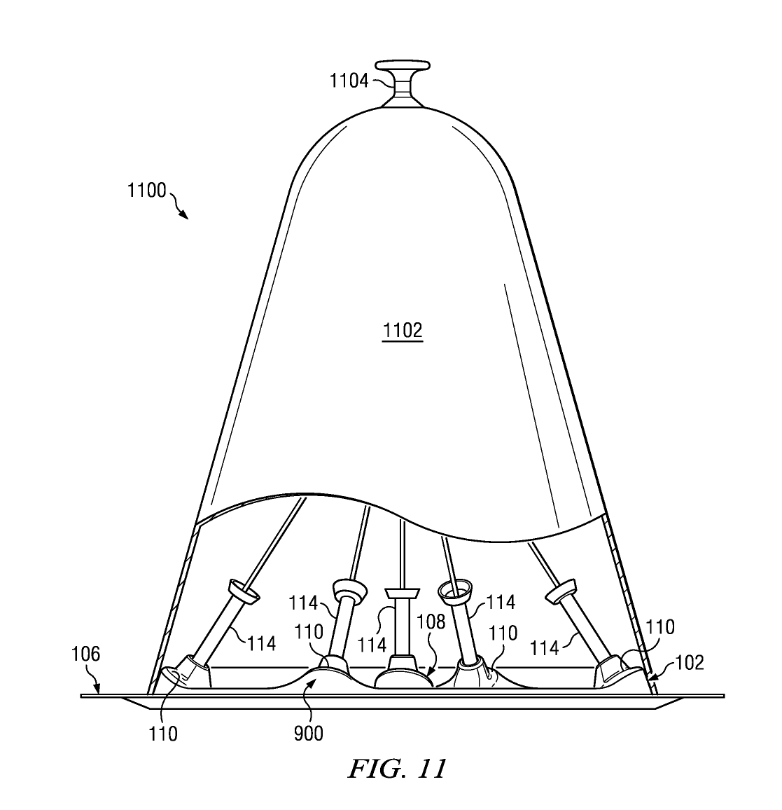

In one embodiment, blades 1202a and 1204b could be coupled together using removable hinge 1206 and aperture 1208 as generally shown in FIGS. 12 and 13. Although a particular structure for hinge 1206 and aperture 1208 is shown in FIGS. 12, 13, and 14 and 1, it should be understood that removable hinge 1206 and aperture 1208 could include any suitable structure, design, size, shape, or configuration according to one embodiment of the present disclosure.

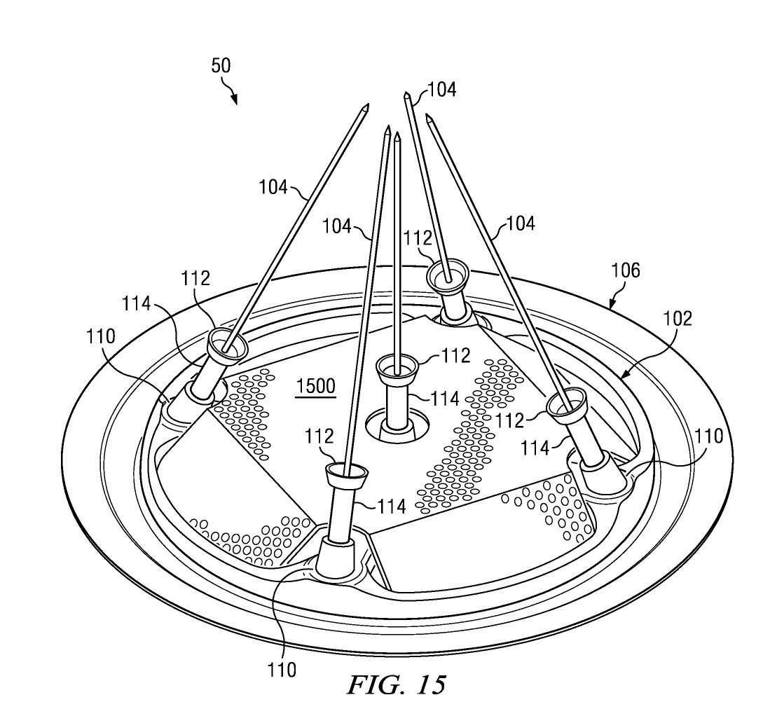

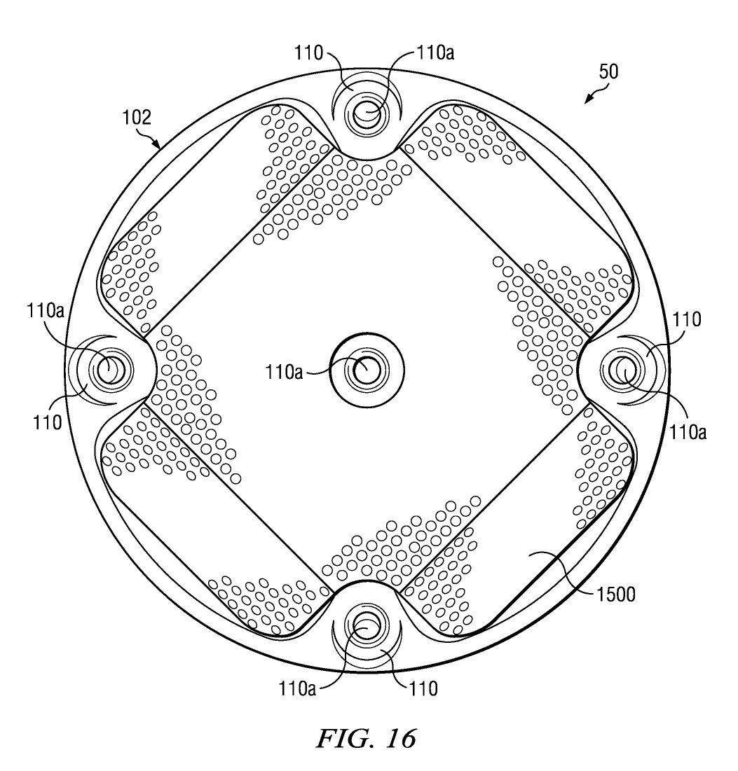

FIGS. 15 and 16 generally illustrate drip screen 1500 for use with system 100a according to one embodiment of the present disclosure. Although a particular structure for drip screen 1500 is shown in FIGS. 15 and 16, it should be understood that drip screen 1500 could include any suitable structure, design, configuration, size, or shape according to one embodiment of the present disclosure. It should also be understood that drip screen 1500 could be used with any system similar to system 100a including, for example, systems 100b, 100c, 100d, 100e, 800, and 1100 described herein.

Screen 1500 could be used in system 100 to filter and screen out solids from liquids and thus allowing liquids to flow through to bowl 402, tray 106, or other retaining device according to one embodiment of the present disclosure. In one embodiment, screen 1500 could include a mesh or sieve-like structure or include a plurality of apertures or openings as shown in FIGS. 15 and 16.

In one embodiment, screen 1500 could hide unsightly juices which could have fallen in tray 106 when flambéing, for example, medium and rare food items. Although a particular structure for screen 1500 is shown in FIGS. 15 and 16, it should be understood that screen 1500 could include any suitable structure, design, size, shape, or configuration according to one embodiment of the present disclosure.

Accordingly, the present disclosure could generally provide a relatively lightweight, safe, easy, and convenient system (e.g., systems 100a-100e and 1100) and method (e.g., method/system 800) to provide flambé presentations at tableside. As alcohol or flambé liquid is poured on the skewered food items, a flambé or fire is ignited and burned in a relatively contained system. Fluid cups on the ends of each skewer and in tray liquids from draining to the handle and thus keep handle of each skewer clean and free from excessive heat.

It may be advantageous to set forth definitions of certain words and phrases used in this patent document. The term “couple,” as well as derivatives thereof, mean to join together by fastening or by association, link, or connect. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A system of displaying food comprising:
a cradle having a retaining structure; and
a skewer having a first end with a removable handle and an open end, wherein the retaining structure is configured to receive a portion of the handle.

2. The system of claim 1, wherein the cradle is a circular structure having two or more retaining structures.

3. The system of claim 1, wherein the retaining structure is configured to receive a portion of the handle at an oblique angle relative to a base of the cradle.

4. The system of claim 1, wherein the handle is threadably connected to an elongated portion of the skewer.

5. The system of claim 1 further comprising:
a concaved cylindrical structure disposed on one end of the handle to capture liquids running from the skewer.

6. The system of claim 1, wherein the retaining structure comprises a cylindrical structure to receive a portion of the handle.

7. The system of claim 1 further comprising:
a dome-shaped cover configured to substantially cover the cradle and the handle when the handle is coupled with the retaining structure.

8. The system of claim 1 further comprising:
a screen configured to selectively engage with juices from food items threaded on the skewer.

9. A system of displaying food comprising:
a cradle having a plurality of retaining structures;
a skewer having a first end with a handle and an open end to thread food items on to the skewer, wherein the retaining structure is configured to receive a portion of the handle; and
a concaved cylindrical structure disposed on one end of the handle to capture liquids running from the skewer.

10. The system of claim 9, wherein the cradle is a circular structure.

11. The system of claim 9, wherein the retaining structure is configured to receive a portion of the handle at an oblique angle relative to a base of the cradle.

12. The system of claim 9, wherein the handle is threadably connected to an elongated portion of the skewer.

13. The system of claim 9, wherein the retaining structure comprises a cylindrical structure to receive a portion of the handle.

14. The system of claim 9 further comprising:
a dome-shaped cover configured to substantially cover the cradle and the handle when the handle is coupled with the retaining structure.

15. The system of claim 9 further comprising:
a screen configured to selectively engage with juices from food items threaded on the skewer.

16. A system of displaying food comprising:
a cradle having a retaining structure; and
a plurality of skewers each having a handle threadably connected to an elongated portion of the skewer, wherein the retaining structure is configured to retain the plurality of skewers and comprises a concaved cylindrical structure disposed on one end of each of the handles to capture liquids running from the skewer.

17. The system of claim 16, wherein the cradle comprises a circular structure.

18. The system of claim 16 further comprising:
a screen configured to selectively engage with the liquids.

19. The system of claim 16, wherein the retaining structure comprises a cylindrical structure to receive a portion of the handle at an oblique angle.

20. The system of claim 16 further comprising:
a dome-shaped cover configured to substantially cover the cradle and the handle when the handle is coupled with the retaining structure.
